(19) United States
(12) Patent Application Publication
(10) Pub. No.: US 2015/0021276 A1
(43) Pub. Date: Jan. 22, 2015

(54) METHOD FOR PRODUCING CHLORINE DIOXIDE

(71) Applicant: KEMIRA OYJ, Helsinki (FI)

(72) Inventors: Risto Rahkola, Sastamala (FI); Ville Stalhandske, Helsinki (FI)

(21) Appl. No.: 14/376,216

(22) PCT Filed: Jan. 23, 2013
(86) PCT No.: PCT/EP2013/051199

§ 371 Date: Aug. 1, 2014

(30) Foreign Application Priority Data
Jan. 31, 2012 (EP) 12153303.8
Jul. 31, 2014 (FI) 20125823

(51) Int. Cl. C02F 1/76

(52) U.S. Cl. CPC C02F 1/76; C02F 2103/28
USPC 210/747.5; 210/754; 210/747.8; 252/175

(57) ABSTRACT

The present invention provides a method for producing chlorine dioxide by reducing sodium chlorate with a reducing agent in the presence of a strong acid comprising feeding ammonium salt to the reactor to produce also chloramine. The present invention also provides a method for disinfecting water.

### FIELD OF THE INVENTION

The present invention relates to a method for producing chlorine dioxide by reducing sodium chlorate with a reducing agent in the presence of a strong acid. More particularly the present invention relates to a method for producing chlorine dioxide wherein also chloramine is produced. The present invention also relates to a method for disinfecting water.

### BACKGROUND OF THE INVENTION

Drinking water is typically produced from raw water which is drawn from surface water such as lake, river, or ground water. Sometimes ground water is pure and requires no treatment, but in most cases harmful substances are present and must be removed or eliminated. Raw water may require multi-step processes such as disinfection, coagulation, flocculation, flotation, sedimentation, filtration, and so on.

Chlorine, ozone, chlorine dioxide and monochloramine are most used chemicals in disinfection of drinking water. Chlorine is typically introduced in the form of hypochlorite. Due to the presence of caustic soda in sodium hypochlorite, the pH of the water is increased. When sodium hypochlorite dissolves in water, two substances form, which play a role in oxidation and disinfection. These are hypochlorous acid (HOCl) and the less active hypochlorite ion (OCl⁻).

Chlorine dioxide is a chemical compound with the formula ClO₂. This yellowish-green gas crystallizes as bright orange crystals at −59° C. It is a potent and useful oxidizing agent used in water treatment and in bleaching. Chlorine dioxide is a highly unstable compound in pure form that can decompose extremely violently. As a result, preparation methods that involve producing solutions of it without going through a gas phase stage are often preferred.

Over 95% of the chlorine dioxide produced in the world today is made from sodium chlorate and is used for pulp bleaching. It is produced with high efficiency by reducing sodium chlorate in a strong acid solution with a suitable reducing agent such as methanol, hydrogen peroxide, hydrochloric acid, or sulfur dioxide. Modern technologies are based on methanol or hydrogen peroxide, as these chemistries allow the best economy and do not co-produce elemental chlorine.

A much smaller, but important, market for chlorine dioxide is for use as a disinfectant. Since 1999 a growing proportion of the chlorine dioxide made globally for water treatment and other small scale applications has been made using the chlorate, hydrogen peroxide and sulfuric acid method which can produce a chlorine-free product at high efficiency.

Chlorine dioxide is typically manufactured on site because of the risk of rapid decomposition. In all processes, chlorine dioxide is produced in strong acid solutions from either sodium chlorite or sodium chlorate. Small- and medium-scale industrial production of chlorine dioxide utilizes sodium chlorite as the raw material. This is typical of water treatment and disinfection applications that require high purity (i.e. chlorine-free) waters. Other applications may utilize sodium chlorate. This is typical for pulp bleaching where large quantities of chlorine dioxide are necessary.

There are several processes used to generate chlorine dioxide from sodium chlorate. In the R2 process, chlorine dioxide is produced from sodium chlorate and sulfuric acid, with sodium chloride as the reducing agent. Chlorine dioxide is absorbed from the gas phase in packed towers in cold water, and chlorine leaves the system as a by-product. This process is described for example in U.S. Pat. No. 2,863,722 by Rapson. The problem of R2 process is that chlorine dioxide is produced with large amounts of chlorine gas. Chlorine is difficult to separate from chlorine dioxide. It requires multiple steps which mean high capital and operational costs. Complex technology is not known to be used in water disinfection.

U.S. 2007183961 describes a process where the aim is to produce more chlorine than chlorine dioxide. When chlorine/chlorine dioxide exceeds ratio 1, it is obvious that more chlorinated disinfection by-products are formed and the role of chlorine dioxide vanishes. Gas phase is separated and the accumulation of chlorine dioxide requires safety considerations. Hydrochloric acid is used as the reaction medium so heating is necessary to achieve good efficiency but it also increases the complexity of the technology. Gaseous mixture of chlorine dioxide and chlorine and water vapor/air is utilized together as a disinfectant in drinking water application. Waste stream is collected separately and it may require neutralization or other handling before discharge because of residuals of gaseous oxidizers.

Chlorine dioxide, chlorine and ammonia may be injected to water treatment separately or together as described in U.S. Pat. No. 6,716,354. In this process monochloramine is prepared with separate ammonia addition, which requires own storage tank, pump, and controls. Ammonia requires safety precautions, since it is corrosive and the gas is dangerous to inhale.

Generally when preparing chlorine dioxide for example for water disinfecting purposes, undesired by-products are present which cannot be utilized or separated. On the other hand, if the by-products need to be low, two or more disinfecting steps are required, such as a first treatment with UV, ozone, or chlorine dioxide followed by a residual addition of active chlorine.

### SUMMARY OF THE INVENTION

The present invention presents one-step technology which is especially suitable for drinking water plants and industrial raw water treatment. Chlorine dioxide is present for fast disinfection, and chloramines such as monochloramine are formed when the reaction mixture is diluted with water to give long-lasting residual disinfection for reservoir and distribution networks.

The present invention provides a method for producing chlorine dioxide and optionally chloramine by reducing sodium chlorate with a reducing agent in the presence of a strong acid in a reactor, comprising feeding ammonium salt to the reactor to produce also chloramine, wherein the concentration of the ammonium nitrogen in the reactor is at least 0.1 mol/l. Further, it is desired that unwanted side products chlorine and ammonium react to chloramine such as monochloramine. Sodium chloride may be used as a co-reducing agent to fix the chlorine:ammonium molar ratio.

The present invention also provides a method for disinfecting water, wherein chlorine dioxide and chloramine are produced to the water to be treated with the method of the invention to disinfect the water.

It is an advantage of the present invention that chlorine dioxide can be produced by using cost-efficient raw materials.

It is another advantage of the present invention that long-term water disinfection is achieved in one step because the formed chloramine acts as a long term disinfectant in addition to the instant disinfectant chlorine dioxide.

### DETAILED DESCRIPTION OF THE INVENTION

The present invention provides a method for producing chlorine dioxide comprising reducing sodium chlorate with a reducing agent in the presence of a strong acid. Also chloramine will be produced in the same process. The reaction is generally carried out in a reactor, tank, vessel, container or the like (which terms may be used interchangeably) containing the reaction mixture. In one example the reaction is carried out in a single reactor, tank, vessel, container or the like. The reactor works most satisfactorily in continuous mode, while batch or semi-batch reactor is also possible. In one embodiment the method is carried out as a continuous process. The reactor type may be e.g. plug-flow reactor, continuous stirred-tank reactor or a combination thereof. It is important to maintain good contact with reactants and avoid accumulation of any components in the reactor.

The method is generally carried out in an aqueous medium by feeding, adding or dosing sodium chlorate, strong acid and reducing agent solutions to a reactor. The concentration of the sodium chlorate solution is typically in the range of 1-10 mol/l, for example in the range of 2-4 mol/l in the feed to the reactor. In one example the method consists of the steps described herein i.e. no further reagents are added and/or no further reaction steps are required.

The strong acid may be for example sulfuric acid, nitric acid, phosphoric acid or hydrochloric acid or mixtures thereof. In one embodiment the strong acid is sulfuric acid. In another embodiment the strong acid is hydrochloric acid. However, when using ammonium sulfate as the ammonium salt, the sulfuric acid is preferred as the solubility of the ammonium sulfate to phosphoric acid or hydrochloric acid may be low. The concentration of the sulfuric acid used may be in the range of 50-98% by weight. In one embodiment the concentration of the sulfuric acid is 90-98% by weight. In one embodiment the concentration of the strong acid, especially sulfuric acid, in the reaction mixture in the reactor is in the range of 3-8 mol/l, such as in the range of 4-6 mol/l.

In the method ammonium salt is added (or fed) to the reactor to produce also chloramine. The ammonium salt may act as the reducing agent but other reducing agent(s) may be used too.

The concentration of the ammonium nitrogen in the reactor is at least 0.1 mol/l, such as at least 0.3 mol/l, for example at least 0.5 mol/l. Generally the concentration of the ammonium nitrogen in the reactor may be less than 2.3 mol/l, such as less than 1.8 mol/l, for example less than 1.3 mol/l. In some examples the concentration of the ammonium nitrogen in the reactor is less than 1 mol/l, such as in the range of 0.1-2.3 mol/l, in the range of 0.1-1.8 mol/l, or in the range of 0.1-1 mol/l. In some examples the concentration of the ammonium nitrogen in the reactor is in the range of 0.3-2.3 mol/l, in the range of 0.3-1.8 mol/l, or in the range of 0.3-1 mol/l. In some examples the concentration of the ammonium nitrogen in the reactor is in the range of 0.5-2.3 mol/l, in the range of 0.5-1.8 mol/l, or in the range of 0.5-1 mol/l. The ammonium nitrogen refers to the nitrogen originating from the ammonium originally fed to the reactor. The original ammonium may be in a different form in the reactor after any reaction has occurred.

In one embodiment the reducing agent comprises ammonium chloride as the ammonium salt. In one example the reducing agent is or consists of ammonium chloride. Ammonium chloride is fed to the reactor as an aqueous solution having concentration typically in the range 1-8 mol/l, such as 2-4 mol/l.

In one embodiment the ammonium salt comprises ammonium sulfate, and the reducing agent comprises sodium chloride or any other suitable reducing agent. In one example the ammonium salt consists of ammonium sulfate. In one example the reducing agent consists of sodium chloride.

In one embodiment the ammonium sulfate is fed to the reactor together with the strong acid, and the reducing agent comprises sodium chloride or any other suitable reducing agent. The ammonium sulfate and the strong acid, such as sulfuric acid, are fed together in the same feed. In one example the ammonium salt consists of ammonium sulfate. In one example the reducing agent consists of sodium chloride.

In one embodiment the mixture of ammonium chloride and sodium chloride is fed to the reactor, wherein the mixture both provides the ammonium salt and acts as the reducing agent. This mixture is fed to the reactor as a separate feed.

The chlorate and chloride are typically used in substantially stoichiometric quantities. However, even a 5% difference in stoichiometric amounts can be used without problems. When the strong acid is sulfuric acid, it is used at least 1 mol/1 mol of chlorate, preferably at least 2 mol/1 mol of chlorate. In one embodiment the amount of sulfuric acid is in the range of about 1-4.5 mol/1 mol of chlorate. In a preferred embodiment the amount of sulfuric acid is in the range of about 2.5 to 4.5 mol/1 mol of chlorate. If the strong acid is hydrochloric acid, the amounts of acid must in general be doubled, such as about 2-9 mol/1 mol of chlorate, preferably about 5-9 mol/1 mol of chlorate.

In one example in a steady state operation the initial reaction mixture contains 3-8 mol/l, preferably 4-6 mol/l sulfuric acid. Chlorate and chloride ion concentrations drop from their initial values to below 0.5 mol/l each, even below 0.1 mol/l as reaction converts them to chlorine dioxide and chlorine, respectively.

Generally the reaction does not require heating or cooling and normal operation temperature may be above ambient temperature, such as about 30-40° C.

Chlorine is a by-product in this process and in right conditions it further reacts with the ammonium ion to form chloramine. This reaction takes place already in the reactor but may also take place when diluting the reaction mixture with water. The present invention therefore also provides a method for producing chlorine dioxide and chloramine by reducing sodium chlorate with a reducing agent in the presence of a strong acid.

In one embodiment the reaction mixture containing chlorine dioxide is diluted after the reaction to obtain chloramine. This dilution may be considered an intermediate step. Any water or aqueous solution can be used but typically the diluent or dilution water is raw water, chemically, physically, or biologically purified water. In this dilution chloramines such as monochloramine are formed and used further to disinfect the water to be treated. In the dilution the pH generally rises over 6, for example to pH about 6-7, thereby facilitating the reaction.

One embodiment provides a method for treating or disinfecting water comprising producing chlorine dioxide and chloramine with any of the methods described herein to the water to be treated to disinfect the water. Chloramine may be formed in the reactor, in the dilution or when the reaction mixture containing chlorine dioxide is fed from the reactor directly to the water to be treated (in situ treatment).

In another embodiment the reaction mixture containing chlorine dioxide is led directly to the water to be treated. In another embodiment the chlorine dioxide and chloramine formed in the reactor are led to the water to be treated. In another embodiment the chlorine dioxide and chloramine formed in the dilution are led to the water to be treated. In one embodiment the water to be treated is raw water, such as groundwater, spring water, or surface water. In one embodiment the raw water is industrial raw water. In one embodiment the water to be treated is drinking water. In one embodiment the water to be treated is reservoir pipeline or distribution pipeline water. In another embodiment the water to be treated is industrial process water, such as process water in pulp or paper industry, such as in paper mill, pulp mill or the like. In still other embodiments of the waters to be treated are industrial process waters, cooling waters, ballast waters, desalination waters, waters in oil industry, or the like. The concentration of chlorine dioxide in the water to be treated may generally be in the range of about 0.1-100 ppm, such as in the range of about 1-50 ppm. If the water to be treated is for example raw water, typical concentration of chlorine dioxide is in the range of 0.1-5 ppm in the water. If the water to be treated is waste water, higher concentrations than 5 ppm might be needed, for example in the range of 5-50 ppm.

The dilution may be carried out in the reactor or at any step after the reactor. In one embodiment the chlorine dioxide solution is diluted to a chlorine dioxide concentration less than 3000 ppm. In another embodiment the chlorine dioxide solution is diluted to a chlorine dioxide concentration less than 300 ppm. Generally the concentrations of at least about 5 ppm are useful, such as concentrations in the range of 5-3000 ppm, such as in the range of 10-2000 ppm or in the range of 10-300 ppm. In one example the range of 20-100 ppm is used. Depending on pH and relative proportions of substances, dichloramine or monochloramine are formed. Monochloramine is preferred in water treatment because of its stability. Chloramine may be utilized in situ and it does not have to be separated and/or recovered from the reaction solution.

When chlorine concentration is in certain level in relation to ammonium it is thought that in a well-mixed reactor only monochloramine is present. Common practice in the literature describes that Cl:N molar ratio should be in the range of 4:1 to 5:1 to achieve maximum conversion to monochloramine. The water to be treated normally contains ammonium so even more chlorine may be needed. This ratio can be adjusted to produce the required amount of chlorine by replacing some ammonium chloride with alkali metal chloride.

This provides a synergistic effect wherein chlorine dioxide provides fast and effective disinfection in small concentrations and monochloramine provides residual chlorine for example in water distribution network.

The reaction parameters such as the temperature and the pressure may be optimized. In one embodiment the reaction temperature is in the range of 20-100° C., such as in the range of 25-100° C. In one embodiment the reaction temperature is in the range of 20-60° C. In one embodiment the reaction pressure is atmospheric. In another embodiment the reaction is made in reduced pressure in the range of 10-100 kPa (absolute). Retention time in the reactor may be in the range of 5-90 minutes, such as in the range of 15-45 minutes. In one embodiment the chlorine dioxide may be diluted with air or other inert gas to prevent the forming of explosive concentrations. Normally about 10% is considered the safety limit for chlorine dioxide gas concentration.

Disinfection efficiency of chlorine dioxide and monochloramine can be further increased by inorganic microbiological active additives. Such substances are for example silver, copper, bromine, iodine, or their salts. Concentration of additive may be in the range of 0.1-10 000 ppm.

### EXAMPLES

### Example 1

The experiments were carried out by using a reactor having a diameter of 57 mm and height of 500 mm. The material of the reactor and the fittings was polyvinylidene fluoride (PVDF), which tolerates well chlorine dioxide.

The reactor did not have any separate heater for speeding up the reaction. Sodium chlorate solution, sulfuric acid and ammonium chloride were fed to the reactor at about 25° C. The reactor did not have any cooler either. Because of this sulfuric acid had to be fed as about 50% solution by weight to prevent warming-up of the reaction mixture. About half of the reactor column was filled with small, about 5 mm long pieces of PVDF tubes. The pieces acted as filling bodies which aim to enhance the mixing of the reactor solution in the reactor.

A continuous process was run by feeding sulfuric acid as about 50 weight-% solution, sodium chlorate as 26.4 weight-% solution, and reducing agent solution, either ammonium chloride as 10 weight-% solution or sodium chloride as 18.8 weight-% solution, into the reactor. The reactor was operated at atmospheric pressure without heating or cooling. Low concentrations (=low conversions) were used for safety reasons to avoid explosive concentrations with proper marginal. Sodium chloride and ammonium chloride were compared as reducing agents. The feed values in Table 1 are calculated to the feed of the 100% substances.

TABLE 1
Sodium chlorate conversion to chlorine dioxide with
different reducing agents.

| | NH₄Cl | NaCl | NaClO₃ | H₂SO₄ | ClO₃ |
|---|---|---|---|---|---|
| Trial | (g/h) | (g/h) | (g/h) | (g/h) | conversion (%) |
| NH₄Cl | 80 | | 220 | 1550 | 46 |
| NaCl | | 100 | 220 | 1400 | 45 |

Chloramines were not analyzed but since chlorine ions and ammonium ions as well are present, they will react to chloramine latest in that step when the reaction mixture is diluted with water and the pH has risen. The feed of chlorides was slightly below the stoichiometric values.

### Example 2

In a 1.0 liter reactor was fed concentrated sulfuric acid (92%) at the rate of 566 g/h, sodium chlorate at the rate of 172 g/h (as 25 weight-% solution) and reducing agent according to Table 2 was dissolved in the chlorate solution. The reactor was not heated or cooled and normal operation temperature was 30-40° C. Pressure in the reactor was kept in partial vacuum. Reaction mixture was injected to approximately 1000 liters of water during one hour. 150 ml samples were taken in a steady state situation. 5 ml of the sample was mixed with 25 ml of borate-buffered water and 10 ml of 10 weight-% potassium iodide solution. Chlorine dioxide and chlorine were analyzed by titration, which is based on Standard Method 4500-ClO₂-B (APHA). The released iodine was titrated by sodium thiosulfate. Chlorine and chlorine dioxide were titrated in neutral pH value. For chlorite ion determination sample was adjusted with sulfuric acid to pH 1-2 before the titration.

Monochloramine was determined by Hach DR5000 UV-Vis Spectrophotometer. Sample was treated with Monochlor F Reagent pillow and phosphate buffer solution was used to adjust the sample to pH 7.5-8. Reagent pillow reacts with monochloramine to form a green-colored indophenol. Green color was measured by Hach DR5000 to get selectively monochloramine concentration.

Table 2
Results from Example 2

| | | | Chlorate | | Chlorine |
|---|---|---|---|---|---|
| | Feed | ClO₂ | conversion | Mono- | conversion to |
| Reducing | rate, | conc. | to ClO₂ | chloramine | monochloramine |
| agent | g/h | (mg/l) | (%)* | conc. (mg/l) | (%) ** |
| 100 mol- | 97 | 107 | 95 | — | — |
| % NaCl | | | | | |
| 50 mol-% | 44 + 49 | 99 | 88 | 9.4 | 26 |
| NH₄Cl + | | | | | |
| 50 mol-% | | | | | |
| NaCl | | | | | |
| 75 mol-% | 67 + 24 | 96 | 86 | 28.4 | 72 |
| NH₄Cl + | | | | | |
| 25 mol-% | | | | | |
| NaCl | | | | | |
| 100 mol- | 89 | 106 | 96 | 32.3 | 69 |
| % NH₄Cl | | | | | |

*2 NaClO₃ + 2 NH₄Cl + 2 H₂SO₄ → 2 ClO₂ + Cl₂ + Na₂SO₄ + (NH₄)₂SO₄ + 2 H₂O;
**Cl₂ + H₂O → HOCl + HCl; NH₄⁺ + HOCl → NH₂Cl + H₂O + H⁺

The ratio of chlorate to monochloramine in the obtained solution was approximately in the range of 10:1 to 3:1. No monochloramine was obtained when sodium chloride alone was used as the reducing agent.

### Example 3

A solution which contained 330 g/l sodium chlorate and 195 g/l sodium chloride was fed into a 1-liter continuously working reactor with one dosing pump at the rate 440 ml/h. Second dosing pump was adjusted to 310 ml/h feeding acid mixture to the reactor. The acid mixture was prepared by dissolving 140 g of ammonium sulfate (analytical grade 99.6%) to 921 ml concentrated sulfuric acid (96.5 weight-%) and letting to dissolve 1 hour.

In a steady state operation reaction products were mixed with 986 l/h of water. A sample was taken and components were analyzed by titration and Hach DR5000 UV-vis spectrophotometer. Chlorate conversion to chlorine dioxide was 97%, chloride conversion to chlorine 87%, ammonium conversion to monochloramine was 52% and chlorine conversion to monochloramine was 52%. Chlorine dioxide production was 90 g/h and monochloramine production was 18 g/h.

Filtrated waste water was treated with different biocides and the bacteria count (colony forming units, CFU/ml) was analyzed from the water after ½ hour and after 4 hours from the adding of the biocide. Cultivations were made by using three dilution factors 10⁻¹, 10⁻² and 10⁻³. Low Nutrient Agar (LNA) was used as a culture dish. Incubation temperature was 22° C. and the cultivation time was 48 hours. The biocide solutions had the following concentrations: Chlorine dioxide+monochloramine (ClO₂+MCA) 101.9 mg/l ClO₂+23.5 mg/l MCA, and chlorine dioxide (ClO₂) 471 mg/l ClO₂+127.2 mg/l Cl₂. The combined total dose has been disclosed in the dose column of Table 3.

TABLE 3
Bacteria count after different treatment.

| | Dose | (CFU/ml) | |
|---|---|---|---|
| Biocide | (mg/l) | ½ h | 4 h |
| Untreated | 0 | 7100 | 5000 |
| ClO₂ + MCA | 0.5 | 160 | 30 |
| | 1 | 110 | 20 |
| | 3 | 40 | 1 |
| ClO₂ | 0.5 | 1200 | 870 |
| | 1 | 210 | 160 |
| | 3 | 50 | 20 |

1. A method for producing chlorine dioxide comprising reducing sodium chlorate with a reducing agent in the presence of a strong acid in a reactor, comprising feeding ammonium salt to the reactor to produce also chloramine, wherein the concentration of the ammonium nitrogen in the reactor is at least 0.1 mol/l.

2. The method of claim 1, characterized in that the reducing agent comprises ammonium chloride as the ammonium salt.

3. The method of claim 1, characterized in that the ammonium salt comprises ammonium sulfate and the reducing agent comprises sodium chloride.

4. The method of claim 3, characterized in that the ammonium sulfate is fed to the reactor together with the strong acid.

5. The method of claim 1, characterized in that a mixture of ammonium chloride and sodium chloride is fed to the reactor.

6. The method of claim 1, characterized in that the strong acid is selected from sulfuric acid, nitric acid, phosphoric acid, hydrochloric acid, and mixtures thereof.

7. The method of claim 1, characterized in that the concentration of the sodium chlorate in the feed to the reactor is in the range of 1-10 mol/l, such as in the range of 2-4 mol/l.

8. The method of claim 1, characterized in that the strong acid and the ammonium chloride are fed into reactor as a mixed solution.

9. The method of claim 6, characterized in that the concentration of the sulfuric acid in the reactor is in the range of 3-8 mol/l, such as in the range of 4-6 mol/l.

10. The method of claim 6, characterized in that the amount of the sulfuric acid is in the range of 1-4.5 mol/1 mol of chlorate.

11. The method of claim 1, characterized in that the method is carried out as a continuous process.

12. The method of claim 1, characterized in that the chlorine dioxide is diluted with water to a concentration in the range of 5-3000 ppm, such as in the range of 10-300 ppm.

13. A method for disinfecting water, comprising producing chlorine dioxide and chloramine to the water with the method of claim 1 to disinfect the water.

14. The method of claim 13, characterized in that the water is drinking water.

15. The method of claim 13, characterized in that the water is industrial process water, such as process water in pulp or paper industry.

16. The method of claim 13, characterized in that the water is raw water or industrial raw water, such as groundwater, spring water, or surface water.

17. The method of claim 13, characterized in that the water is reservoir or distribution pipeline water.
